(19) United States
(12) Patent Application Publication
(10) Pub. No.: US 2013/0014785 A1
(43) Pub. Date: Jan. 17, 2013

(54) SUBSTRATE PROCESSING METHOD AND SUBSTRATE PROCESSING APPARATUS

(71) Applicants: Masahiro KIMURA, Kyoto (JP); Masayuki OTSUJI, Kyoto (JP)

(72) Inventors: Masahiro KIMURA, Kyoto (JP); Masayuki OTSUJI, Kyoto (JP)

(21) Appl. No.: 13/523,186

(22) Filed: Jun. 14, 2012

(30) Foreign Application Priority Data
Jul. 13, 2011 (JP) 2011-154632

(51) Int. Cl. B08B 5/00

(52) U.S. Cl. 134/31; 134/94.1

(57) ABSTRACT

A substrate processing method includes a removing step of removing unwanted matter from a substrate and a vaporizing step performed in parallel to the removing step. In the removing step, an HF vapor that contains hydrogen fluoride and a solvent vapor that contains a solvent capable of dissolving water and having a lower boiling point than water is supplied onto the substrate to etch and remove the unwanted matter. In the vaporizing step, the solvent on the substrate is vaporized.

### BACKGROUND OF THE INVENTION

1. Field of the Invention

The present invention relates to a substrate processing method and a substrate processing apparatus for processing a substrate. Examples of substrates to be processed include semiconductor wafers, substrates for liquid crystal displays, substrates for plasma displays, substrates for FEDs (Field Emission Displays), substrates for optical disks, substrates for magnetic disks, substrates for magneto-optical disks, substrates for photomasks, ceramic substrates, substrates for solar cells, etc.

2. Description of Related Art

In a manufacturing process for a semiconductor device or a liquid crystal display, an etching step of supplying hydrofluoric acid (an aqueous solution of hydrogen fluoride) to a semiconductor wafer or a glass substrate for liquid crystal display to remove an unwanted film from the substrate and a cleaning step of removing particles from the substrate are performed. For example, a substrate processing method, in which hydrofluoric acid is supplied to a substrate to remove a residue of an unwanted film from the substrate is disclosed in Japanese Patent No. 4403202. After the supplying of hydrofluoric acid to the substrate, pure water is supplied as a rinse liquid to the substrate to rinse off the hydrofluoric acid. The liquid is thereafter removed from the substrate to dry the substrate.

There are cases where patterns formed on a surface of the substrate collapse when the substrate is being dried by removal of the liquid from the substrate. Collapse occurs especially readily with patterns of high aspect ratio. Pattern collapse occurs because a force that tilts the patterns is generated by surface tension of the liquid present between the patterns. Pattern collapse can therefore be suppressed or prevented by using a vapor instead of a liquid.

However, when a substrate is processed using a vapor of hydrofluoric acid, a new residue forms as shall be described below. Pure water must thus be supplied to the substrate to remove the residue from the substrate. However, when the substrate to which the pure water has been supplied is dried, the patterns formed on the substrate surface may collapse due to the surface tension of the pure water.

### SUMMARY OF THE INVENTION

A preferred embodiment of the present invention provides a substrate processing method and a substrate processing apparatus by which pattern collapse and residue formation can be suppressed or prevented.

A substrate processing method according to a preferred embodiment of the present invention is a method for removing unwanted matter from a substrate by etching and includes a removing step of supplying an HF vapor that contains hydrogen fluoride and a solvent vapor that contains a solvent capable of dissolving water and having a lower boiling point than water to the substrate to etch and remove the unwanted matter, and a vaporizing step of vaporizing the solvent on the substrate in parallel with the removing step.

The HF vapor may be a vapor of hydrofluoric acid or a gas that contains a vapor of hydrofluoric acid. For example, the HF vapor may be gas that contains a vapor of hydrofluoric acid and a carrier gas. Likewise, the solvent vapor may be a vapor of the solvent or may be a gas that contains a vapor of the solvent.

Also, the removing step may be a step of supplying the HF vapor and the solvent vapor separately to the substrate to mix the HF vapor and the solvent vapor at the substrate or may be a step of supplying the HF vapor and the solvent vapor in a mixed state onto the substrate.

Also, the vaporizing step may be a heating step of heating the solvent on the substrate, or may be a pressure reducing step of reducing a gas pressure, or may be a heating and pressure reducing step of heating the solvent on the substrate and reducing the gas pressure.

When the HF vapor that contains hydrogen fluoride (HF) is supplied to silicon dioxide (SiO₂), the reaction, “SiO₂+HF→H₂SiF₆+2H₂O, ” occurs and hexafluorosilicic acid (H₂SiF₆) and water (H₂O) are produced. Research by the present inventor has shown that if water remains on the substrate when HF vapor is supplied, “H₂SiF₆ ·8H₂O” is formed as a byproduct and this byproduct remains as a residue on the substrate.

Without water, hexafluorosilicic acid decomposes into SiF₄ and HF and sublimates. Thus, by removing water in parallel with the etching of silicon dioxide, the forming of a residue can be suppressed or prevented.

With the substrate processing method according to the preferred embodiment of the present invention, the HF vapor and the solvent vapor liquefies on the substrate and fine droplets of hydrogen fluoride and fine droplets of the solvent are thereby supplied onto the substrate. An unwanted film and unwanted matter, such as particles, on the substrate are etched and removed by the supplying of hydrogen fluoride. Also, water is soluble in the solvent and the water produced by the etching dissolves into the solvent. Further, the boiling point of the solvent is lower than the boiling point of water and the solvent thus vaporizes and is removed from the substrate rapidly. The water dissolved in the solvent is removed from the substrate along with the solvent. A residual amount of water is thereby reduced. Water thus continues to be removed from the substrate while the unwanted matter is being etched, and the residual amount of water can thus be reduced. The formation of residue can thereby be suppressed or prevented. Further, the unwanted matter is removed using the vapors so that collapse of patterns formed on the substrate surface can be suppressed or prevented.

The solvent may contain at least one of either of a fluorine-based solvent capable of dissolving water and having a lower boiling point than water and an alcohol capable of dissolving water and having a lower boiling point than water.

Preferably, the substrate processing method according to the preferred embodiment of the present invention further includes a solvent vapor supplying step of supplying the solvent vapor to the substrate in a state where the supplying of the HF vapor to the substrate is stopped after performing the removing step.

The solvent contained in the solvent vapor supplied to the substrate in the solvent vapor supplying step and the solvent contained in the solvent vapor supplied onto the substrate in the removing step may be the same type of solvent or may be different types of solvents.

There may be cases where fluorine (including fluorine ions) is produced on the substrate when the HF vapor is supplied onto the substrate in the removing step because hydrogen fluoride is contained in the HF vapor.

By the present method, the fluorine can be removed from the substrate by the supplying of the solvent vapor. A residual amount of fluorine can thereby be reduced. The substrate can thereby be increased in cleanliness.

Preferably, the removing step includes a ratio changing step of changing a ratio of the HF vapor to the solvent vapor supplied to the substrate.

By including the ratio changing step, a proportion of the solvent vapor can be increased or decreased in accordance with a removal amount of unwanted matter. For example, if the removal amount of unwanted matter increases, the amount of water produced by etching increases. Thus, by increasing the proportion of the solvent vapor, the water produced due to etching can be removed reliably from the substrate. The formation of residue can thereby be suppressed or prevented.

Preferably, the substrate processing method according to the preferred embodiment of the present invention further includes a vapor removing step of removing the HF vapor and the solvent vapor from the substrate exposed to the HF vapor and the solvent vapor after performing the removing step.

By including this step, the HF vapor and the solvent vapor supplied onto the substrate in the removing step and floating in a vicinity of the substrate are removed. Forming of fine droplets on the substrate by attachment of the HF vapor and the solvent vapor to the substrate can thereby be suppressed or prevented. Further, fine droplets that are attached to the substrate can be removed. The substrate is thereby maintained, from the removing step through the vapor removing step, in a dry state, that is, in a state where intervals between patterns formed on the substrate are not filled with liquid. Collapse of the patterns due to surface tension of a liquid present between the patterns can thus be suppressed or prevented.

Preferably, the removing step is a step of supplying, to the substrate, the HF vapor and the solvent vapor having a water concentration that are in accordance with a type of the unwanted matter.

Depending on the type of unwanted matter, an etching rate (removal amount per unit time) may be low under an environment in which water is not present. Thus, by supplying HF vapor with a high water concentration to a substrate that includes such unwanted matter, a processing time can be shortened. Also, depending on the type of the unwanted matter, the etching rate may be high and the amount of water produced per unit time during etching may be high. Thus, by supplying HF vapor that is low in water concentration to a substrate that includes such unwanted matter, the amount of water on the substrate can be reduced to suppress or prevent residue formation.

A substrate processing apparatus according to a preferred embodiment of the present invention includes a substrate holding unit that holds a substrate, a vapor supplying unit that supplies, onto the substrate held by the substrate holding unit, an HF vapor that contains hydrogen fluoride and a solvent vapor that contains a solvent capable of dissolving water and having a lower boiling point than water, a vaporizing unit that vaporizes the solvent on the substrate held by the substrate holding unit, and a control unit. The control unit executes a removing step of controlling the vapor supplying unit to supply the HF vapor and the solvent vapor to the substrate held by the substrate holding unit and thereby etch and remove unwanted matter from the substrate and executes a vaporizing step of controlling the vaporizing unit to vaporize the solvent on the substrate in parallel to executing the removing step. By the present arrangement, the same effects as the effects described in relation to the substrate processing method can be exhibited.

The vapor supplying unit may supply, onto the substrate held by the substrate holding unit, the solvent vapor, containing at least one of either of a fluorine-based solvent capable of dissolving water and having a lower boiling point than water and an alcohol capable of dissolving water and having a lower boiling point than water, and the HF vapor.

Preferably, the substrate processing apparatus according to the preferred embodiment of the present invention further includes a solvent vapor supplying unit that supplies the solvent vapor onto the substrate held by the substrate holding unit. The control unit further executes a solvent vapor supplying step of controlling the vapor supplying unit and the solvent vapor supplying unit to supply the solvent vapor to the substrate in a state where the supplying of the HF vapor to the substrate is stopped after executing the removing step.

The solvent contained in the solvent vapor supplied onto the substrate by the solvent vapor supplying unit and the solvent contained in the solvent vapor supplied onto the substrate in the removing step may be the same type of solvent or may be different types of solvents.

There may be cases where fluorine (including fluorine ions) is produced when the HF vapor is supplied onto the substrate in the removing step because hydrogen fluoride is contained in the HF vapor. By the present apparatus, the fluorine can be removed from the substrate by the supplying of the solvent vapor. The residual amount of fluorine can thereby be reduced. The substrate can thereby be increased in cleanliness.

Preferably, the vapor supplying unit includes a ratio changing unit that changes a ratio of the HF vapor to the solvent vapor supplied onto the substrate. In this case, the control unit preferably executes a ratio changing step of controlling the ratio changing unit to change the ratio of the

HF vapor and the solvent vapor supplied to the substrate in the removing step. By including the ratio changing unit, the proportion of the solvent vapor can be increased or decreased in accordance with the removal amount of unwanted matter. For example, if the removal amount of unwanted matter increases, the amount of water produced by etching increases. Thus, by increasing the proportion of the solvent vapor, the water produced due to etching can be removed reliably from the substrate. Residue formation can thereby be suppressed or prevented.

Preferably, the substrate processing apparatus according to the preferred embodiment of the present invention further includes a vapor removing unit that removes a vapor. Preferably, the control unit further executes a vapor removing step of controlling the vapor removing unit to remove the HF vapor and the solvent vapor from the substrate exposed to the HF vapor and the solvent vapor after executing the removing step.

By including the vapor removing unit, the HF vapor and the solvent vapor supplied to the substrate in the removing step and floating in a vicinity of the substrate are removed. Forming of fine droplets on the substrate due to attachment of the HF vapor and the solvent vapor to the substrate can thereby be suppressed or prevented. Further, fine droplets that are attached to the substrate can be removed.

Preferably, the vapor supplying unit further includes a first vapor supplying unit that supplies a first HF vapor, containing hydrogen fluoride, and the solvent vapor to the substrate held by the substrate holding unit, and a second vapor supplying unit that supplies a second HF vapor, containing hydrogen fluoride and water and being higher in water concentration than the first HF vapor, and the solvent vapor to the substrate held by the substrate holding unit. The control unit controls the first vapor supplying unit and the second vapor supplying unit in accordance with the type of the unwanted matter to supply either the first or the second HF vapor and the solvent vapor onto the substrate in the removing step. Depending on the type of unwanted matter, the etching rate (removal amount per unit time) may be low under an environment in which water is not present. Thus, by supplying HF vapor that is high in water concentration to a substrate that includes such unwanted matter, the processing time can be shortened. Also, depending on the type of the unwanted matter, the etching rate may be high and the amount of water produced per unit time during etching may be high. Thus, by supplying HF vapor that is low in water concentration to a substrate that includes such unwanted matter, the amount of water on the substrate can be reduced to suppress or prevent residue formation.

The aforementioned and other objects, features, and effects of the present invention shall be clarified by the following description of a preferred embodiment with reference to the accompanying drawings.

### BRIEF DESCRIPTION OF THE DRAWINGS

FIG. 1 is a schematic plan view of a layout of a substrate processing apparatus according to a preferred embodiment of the present invention.

FIG. 2 is a schematic longitudinal sectional view of a general arrangement of a vapor etching unit.

FIG. 3 is a flowchart for describing an example of substrate processing performed by the substrate processing apparatus.

FIG. 4 is a flowchart for describing an example of substrate processing performed by the substrate processing apparatus.

FIG. 5A is schematic view for describing a state of a substrate during processing in a comparative example.

FIG. 5B is schematic view for describing a state of a substrate during processing in an example.

FIG. 6 is schematic view for describing a state of a substrate during processing.

FIG. 7 is schematic view for describing a state of a substrate during processing.

### DETAILED DESCRIPTION OF THE PREFERRED EMBODIMENTS

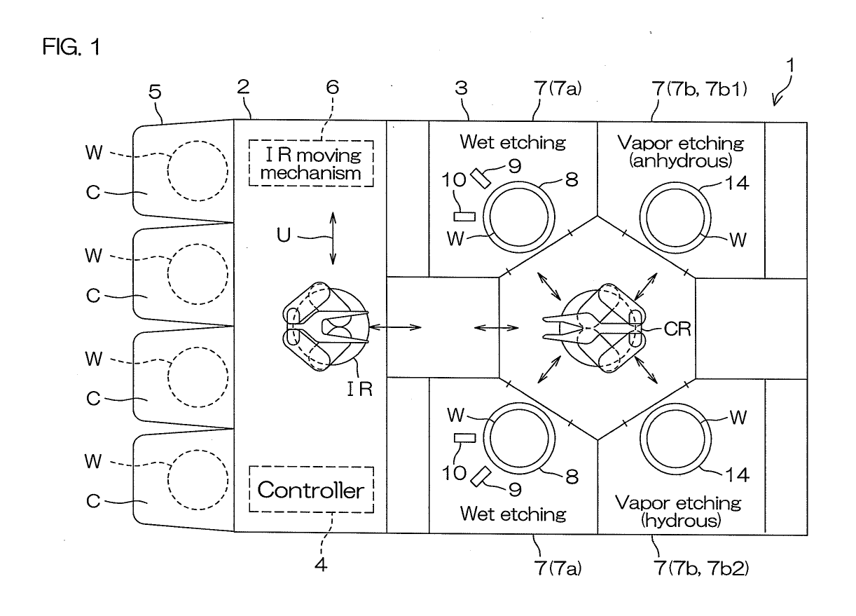

FIG. 1 is a schematic plan view of a layout of a substrate processing apparatus 1 according to a preferred embodiment of the present invention.

The substrate processing apparatus 1 is a one-by-one type substrate processing apparatus that processes disk-like substrates W, such as semiconductor wafers, one by one by processing liquids, such as a chemical solution, a rinse liquid. The substrate processing apparatus 1 includes an indexer block 2, a processing block 3 coupled to the indexer block 2, and a controller 4 (control unit) that controls operations of devices and opening/closing of valves provided in the substrate processing apparatus 1.

The indexer block 2 includes a carrier holding portion 5, an indexer robot IR, and an IR moving mechanism 6. A plurality of carriers C that house the substrates W are held by the carrier holding portion 5 in a state of being aligned in a horizontal carrier alignment direction U. The IR moving mechanism 6 moves the indexer robot IR in the carrier alignment direction U. The indexer robot IR performs a carry-in operation of carrying the substrate W to each of the plurality of carriers C held by the carrier holding portion 5 and a carry-out operation of carrying out the substrate W from each of the plurality of carriers C. The substrates W are conveyed by the indexer robot IR.

The processing block 3 includes a plurality (for example, no less than four) processing units 7 that process the substrates W and a center robot CR. The plurality of processing units 7 are, for example, disposed so as to surround the center robot CR in a plan view. The center robot CR performs a carry-in operation of carrying the substrates W to the processing units 7 and a carry-out operation of carrying out the substrates W from the processing units 7. Further, the center robot CR conveys the substrates W among the plurality of processing units 7. The center robot CR receives the substrates W from the indexer robot IR and hands over the substrates W to the indexer robot IR. The indexer robot IR and the center robot CR are controlled by the controller 4.

The plurality of processing units 7 include wet etching units 7a each supplying an etching solution, which is an example of an etching agent, to the substrate W and etching the substrate W, and vapor etching units 7b each supplying an etching vapor, which is an example of an etching agent, to the substrate W and etching the substrate W. Each wet etching unit 7a includes a spin chuck 8 that horizontally holds the substrate W and rotates the substrate W around a vertical axis passing through a center of the substrate W, an etching nozzle 9 that supplies the etching solution to the substrate W held by the spin chuck 8, and a rinse liquid nozzle 10 that supplies a rinse liquid to the substrate W held by the spin chuck 8. Also, the vapor etching units 7b include an anhydrous vapor etching unit 7b1 (vapor supplying unit, first vapor supplying unit) and a hydrous vapor etching unit 7b2 (vapor supplying unit, second vapor supplying unit). The anhydrous vapor etching unit 7b1 and the hydrous vapor etching unit 7b2 have an arrangement in common. The vapor etching units 7b1 and 7b2 shall now be described.

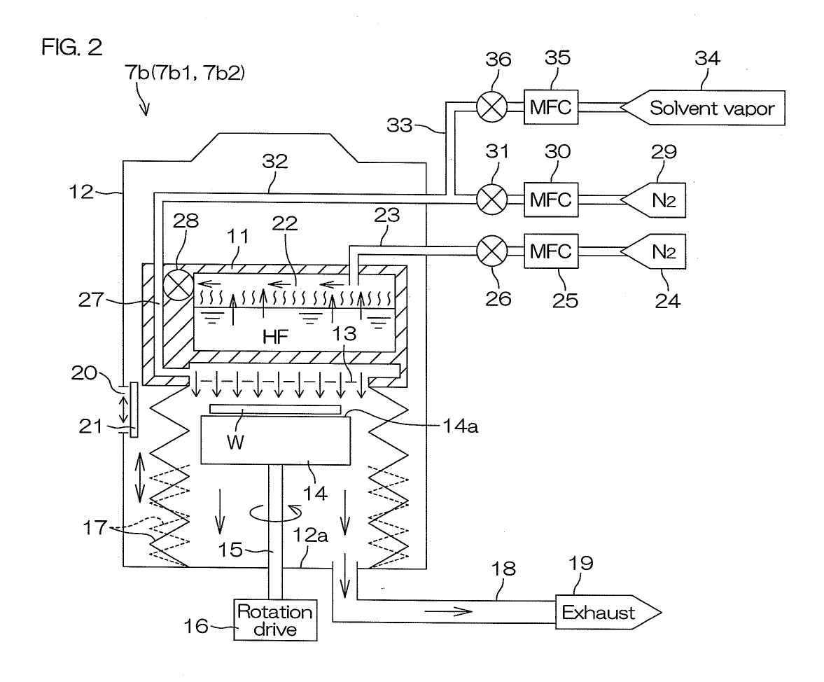

FIG. 2 is a schematic longitudinal sectional view of a general arrangement of either of the vapor etching units 7b1 and 7b2.

Each of the vapor etching units 7b1 and 7b2 has an HF vapor generating container 11 (vapor supplying unit) that stores hydrofluoric acid in a sealed state and a housing 12 that houses the HF vapor generating container 11. A punching plate 13, in which are formed a plurality of through-holes that discharge a gas downward, is provided below the HF vapor generating container 11. Further, below the punching plate 13 is disposed a hotplate 14 (substrate holding unit, vaporizing unit) that horizontally holds the substrate W in a state where the substrate W faces the punching plate 13. The substrate W held by the hotplate 14 is heated by the hotplate 14. The hotplate 14 is fixed on an upper end of a rotating shaft 15. When a rotation drive mechanism 16 that includes a motor, etc., rotates the rotating shaft 15, the hotplate 14 rotates around a vertical axis together with the rotating shaft 15. The substrate W held by the hotplate 14 is thereby made to rotate about the vertical axis passing through the center of the substrate W.

The vapor etching unit 7b further includes a cylindrical bellows 17 disposed at a periphery of the hotplate 14. The hotplate 14 is disposed at an inner side of the bellows 17. The bellows 17 is vertically contractible with respect to a bottom surface 12a of the housing 12. A drive mechanism (not shown in FIG. 2) expands and contracts the bellows 17 between a sealing position (position indicated by solid lines) at which an upper end edge of the bellows 17 contacts the punching plate 13 and a space in the periphery of the hotplate 14 is sealed and a retracted position (position indicated by broken lines) at which the upper end edge of the bellows 17 is retracted below an upper surface 14a of the hot plate 14. An exhausting apparatus 19 (vapor removing unit) exhausts gas inside the bellows 17 via an exhaust pipe 18 connected to the bottom surface 12a of the housing 12.

Also, an opening 20 positioned at a side of the hotplate 14 is formed in a side wall of the housing 12. The opening 20 is opened and closed by a shutter 21. When the substrate W is carried into the vapor etching unit 7b, the bellows 17 is positioned at the retracted position (position indicated by the broken lines) in advance and the opening 20 is opened. In this state, the substrate W is placed on the hot plate 14 by the center robot CR. Thereafter, the opening 20 is closed by the shutter 21. On the other hand, when the substrate W is carried out from the vapor etching unit 7b, the bellows 17 is positioned at the retracted position and the opening 20 is opened. In this state, the substrate W held by the hot plate 14 is carried out by the center robot CR. Thereafter, the opening 20 is closed by the shutter 21.

The HF vapor generating container 11 has a vapor generating space 22 formed inside the HF vapor generating container 11. In the anhydrous vapor etching unit 7b1, hydrofluoric acid, which is lower in water concentration than that of the hydrous vapor etching unit 7b2, is stored in the HF vapor generating container 11. Specifically, for example, anhydrous hydrofluoric acid with a hydrogen fluoride concentration of no less than 99.9% is stored in the HF vapor generating container 11 in the anhydrous vapor etching unit 7b1. Also, in the hydrous vapor etching unit 7b2, for example, hydrofluoric acid that has been adjusted to a concentration of a so-called pseudo-azeotropic composition (for example, approximately 39.6% at 1 atm and room temperature) is stored in the HF vapor generating container 11. The HF vapor generated at the anhydrous vapor etching unit 7b1 is a first HF vapor that contains hydrogen fluoride, and the HF vapor generated at the hydrous vapor etching unit 7b2 is a second HF vapor that contains hydrogen fluoride and water and is higher in water concentration than the first HF vapor.

A first piping 23 supplying nitrogen gas, which is an example of a carrier gas, to the vapor generating space 22 is connected to the HF vapor generating container 11. Nitrogen gas from a first N₂ supply source 24 is supplied to the vapor generating space 22 via a first flow controller 25 (MFC, ratio changing unit), a first valve 26, and the first piping 23. Also, the HF vapor generating container 11 has a flow passage 27 formed in the HF vapor generating container 11. The vapor generating space 22 is connected to the flow passage 27 via a communicating valve 28. Nitrogen gas from a second N₂ supply source 29 (vapor removing unit) is supplied to the flow passage 27 via a second flow controller 30, a second valve 31, and a second piping 32.

In a state where the first valve 26 and the communicating valve 28 are open, the HF vapor floating in the vapor generating space 22 is supplied to the flow passage 27 via the communicating valve 28 by the flow of nitrogen gas. Thus, in the state where the first valve 26, the second valve 31, and the communicating valve 28 are open, the HF vapor supplied to the flow passage 27 is guided to the punching plate 13 by the flow of the nitrogen gas supplied to the flow passage 27 from the second piping 32. The HF vapor is thereby blown onto the substrate W held by the hotplate 14.

Also, a third piping 33 (vapor supplying unit, solvent vapor supplying unit) supplying a solvent vapor, which contains a solvent, to the flow passage 27 is connected to the HF vapor generating container 11. The third piping 33 is connected to the second piping 32 at a location further downstream than the second valve 31 and the second flow controller 30. The third piping 33 is thus connected to the flow passage 27 via the second piping 32. The solvent vapor from a solvent vapor supply source 34 is supplied to the second piping 32 via a third flow controller 35 (ratio changing unit), a third valve 36, and the third piping 33. The solvent vapor supplied to the second piping 32 flows into the flow passage 27 from the second piping 32 and is guided to the punching plate 13. The solvent vapor is thereby blown onto the substrate W held by the hotplate 14.

The solvent contained in the solvent vapor is capable of dissolving water and has a boiling point lower than water. The solvent contained in the solvent vapor is preferably nonflammable. As an example of the solvent contained in the solvent vapor, at least one of either of a fluorine-based solvent capable of dissolving water and having a lower boiling point than water and an alcohol capable of dissolving water and having a lower boiling point than water can be cited. The fluorine-based solvent may, for example, be HFE (hydrofluoroether), and the alcohol may include at least one substance among methanol, ethanol, and IPA (isopropyl alcohol). As a specific example of the solvent contained in the solvent vapor, a mixture of HFE and IPA (with HFE making up 95% and IPA making up 5%) can be cited.

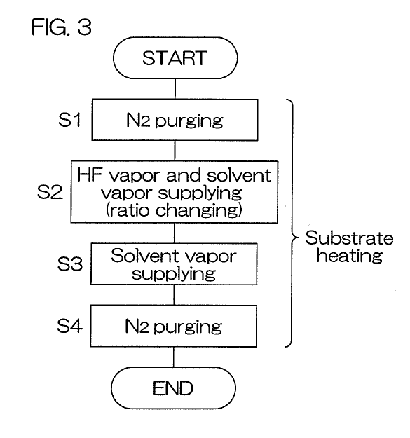

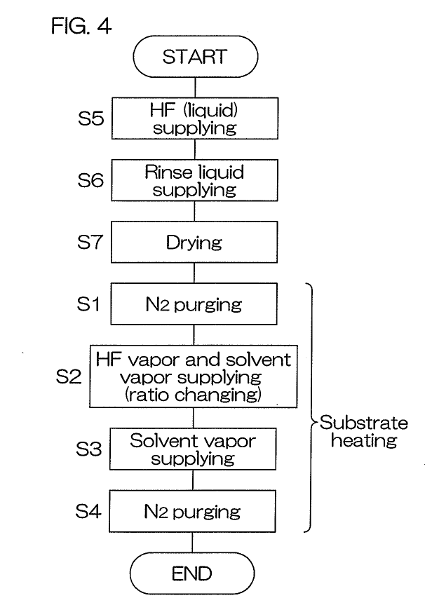

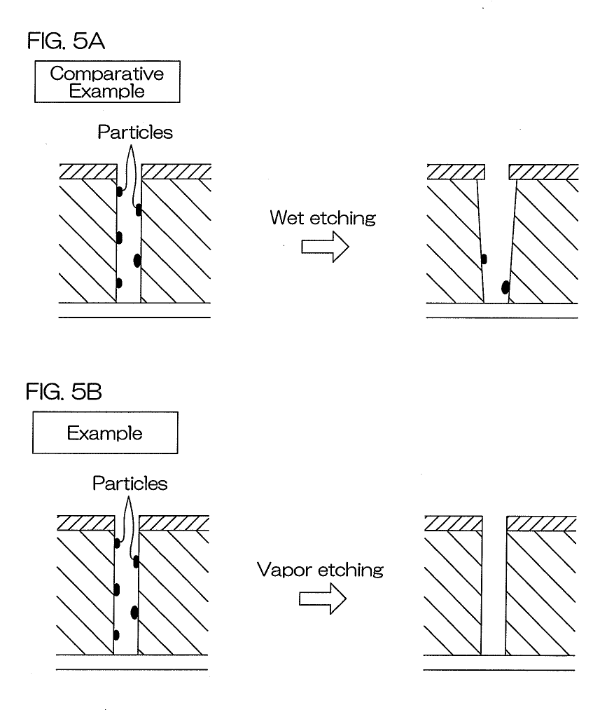

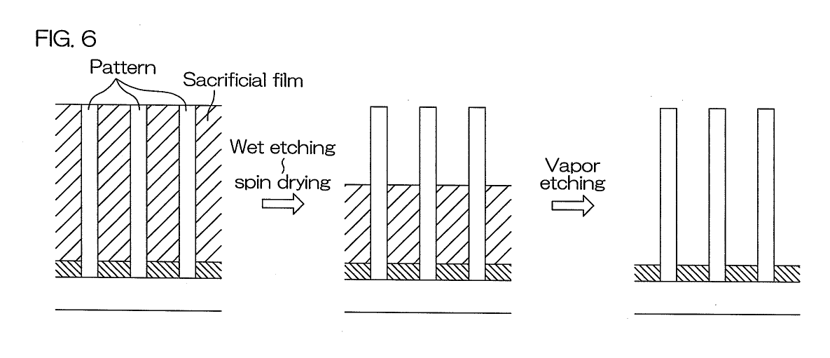

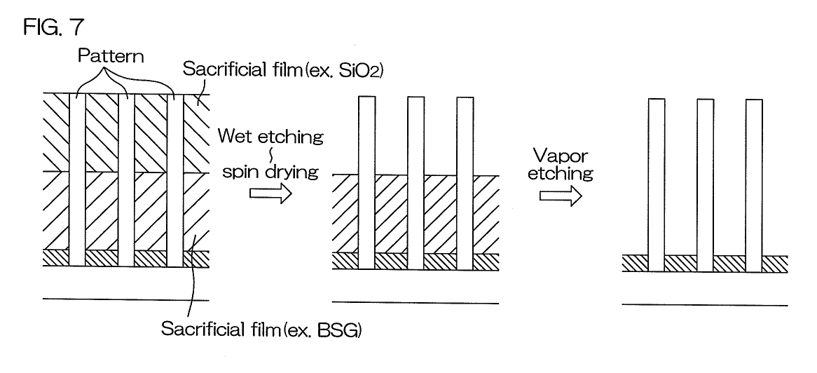

FIG. 3 and FIG. 4 are flowcharts for describing examples of processing of the substrate W performed by the substrate processing apparatus 1. FIG. 5A, FIG. 5B, FIG. 6, and FIG. 7 are schematic views for describing states of the substrate W during processing. In the following description, a processing example where SiO₂-containing unwanted matter, such as a sacrificial film, particles, are removed from the substrate W by supplying hydrogen fluoride to the substrate W that is constantly heated by the hot plate 14 shall be described. First, a first processing example shown in FIG. 3 shall be described. FIG. 2 and FIG. 3 shall be referenced in the following description.

### [First Processing Example]

After the substrate W has been set on the hotplate 14 by the center robot CR, the atmosphere inside the bellows 17 is replaced with nitrogen gas (S1). Specifically, the controller 4 opens the second valve 31 in a state where the bellows 17 is positioned at the sealed position (position indicated by the solid lines) and the exhausting apparatus 19 is being driven. Nitrogen gas is thereby supplied from the second piping 32 to the flow passage 27 and the nitrogen gas is supplied from the punching plate 13 into the bellows 17. The atmosphere inside the bellows 17 is exhausted to the exhaust piping 18 by a suction force of the exhausting apparatus 19 and forced out into the exhaust piping 18 by the nitrogen gas supplied into the bellows 17. The atmosphere inside the bellows 17 is thereby replaced with nitrogen gas. After the atmosphere inside the bellows 17 has been replaced with nitrogen gas, the controller 4 closes the second valve 31.

Thereafter, the HF vapor and the solvent vapor are supplied to the substrate W (S2). Specifically, the controller 4 makes the rotation drive mechanism 16 rotate the substrate W held by the hotplate 14 in a state where a temperature of the substrate W itself and a periphery of the substrate W is maintained by the hotplate 14 at a temperature no less than the boiling point of the solvent (for example, a fixed temperature within a range from 40 to 150° ). Thereafter, the controller 4 opens the first valve 26, the third valve 36, and the communicating valve 28. The HF vapor and the solvent vapor are thereby supplied to the flow passage 27. The HF vapor and the solvent vapor that are supplied to the flow passage 27 mix together inside the flow passage 27 and pass through the through-holes of the punching plate 13 in a mixed state. The HF vapor and the solvent vapor are thereby blown onto the substrate W that is in the rotating state and is maintained at the fixed temperature by the hotplate 14.

The HF vapor and the solvent vapor that are blown onto the substrate W liquefy on the substrate W. Fine droplets of hydrogen fluoride and fine droplets of the solvent are thereby supplied to the substrate W. Unwanted matter, such as a sacrificial film, particles, is etched and removed by the supplying of hydrogen fluoride. Also, water is soluble in the solvent and thus water produced due to etching dissolves into the solvent. Further, in parallel to supplying the HF vapor and the solvent vapor to the substrate W, the substrate W and the atmosphere is heated by the hotplate 14 and the solvent having the boiling point lower than water is thus vaporized and removed rapidly from the substrate W. The water dissolved in the solvent is removed from the substrate W along with the solvent. The water produced by etching thus continues to be removed while the unwanted matter on the substrate W is being etched. The residual amount of water is thereby reduced. Residue formation is thus suppressed or prevented.

Thereafter, the solvent vapor is supplied to the substrate W (S3). Specifically, the controller 4 closes the first valve 26 and the communicating valve 28 while keeping the third valve 36 open. The supplying of the HF vapor to the flow passage 27 is thereby stopped. Thus, only the solvent vapor is supplied to the flow passage 27. Thus, only the solvent vapor passes through the through-holes of the punching plate 13 and is supplied to the substrate W held by the hotplate 14.

The fluorine (including fluorine ions) produced by the supplying of the HF vapor is thereby removed from the substrate W. The residual amount of fluorine on the substrate W is thus reduced. The controller 4 closes the third valve 36 after the supplying of the solvent vapor to the substrate W has been performed for a predetermined time.

Thereafter, the atmosphere inside the bellows 17 is replaced with nitrogen gas again (S4). Specifically, the controller 4 opens the second valve 31. Nitrogen gas is thereby supplied into the bellows 17. The atmosphere inside the bellows 17, that is, the HF vapor and the solvent vapor floating inside the bellows 17 and gases formed by the etching of the substrate W are exhausted to the exhaust piping 18 by the suction force of the exhausting apparatus 19 and is forced out into the exhaust piping 18 by the nitrogen gas supplied into the bellows 17.

The atmosphere inside the bellows 17 is thereby replaced with nitrogen gas. Formation of droplets on the substrate W due to attachment of the HF vapor and the solvent vapor remaining inside the bellows 17 to the substrate W can thereby be suppressed or prevented. Further, even if droplets are attached to the substrate W, the droplets can be vaporized and removed from the substrate W by the supplying of the nitrogen gas. After the atmosphere inside the bellows 17 has been replaced with nitrogen gas, the controller 4 closes the second valve 31. Thereafter, the substrate W in a dry state is carried out from the hotplate 14 by the center robot CR.

The HF vapor is supplied to the substrate W and the unwanted matter is removed from the substrate W as described above. The controller 4 may perform the above process at either of the anhydrous vapor etching unit 7b1 and the hydrous vapor etching unit 7b2. For example, the controller 4 may select between use of the anhydrous vapor etching unit 7b1 and use of the hydrous vapor etching unit 7b2 in accordance with the type of sacrificial film. That is, by which of the anhydrous vapor etching unit 7b1 and the hydrous vapor etching unit 7b2 the substrate W is to be processed may be set by a recipe (processing details for the substrate W) in accordance with the type of the sacrificial film. In this case, the controller 4 may select between use of the anhydrous vapor etching unit 7b1 and use of the hydrous vapor etching unit 7b2 based on the recipe.

In a case where the sacrificial film is an oxide film (a film made of SiO₂), even if the HF vapor is supplied to the substrate W, an etching rate (removal amount per unit time) will be low under an environment in which water is not present. Thus, in this case, the controller 4 may make an HF vapor of high water concentration be supplied to the substrate W by the hydrous vapor etching unit 7b2. On the other hand, a BSG film (an SiO₂ film containing boron) is higher in etching rate than an oxide film. The amount of water produced per unit time during etching is thus high. Water may thus remain. Thus, in this case, the controller 4 may make an HF vapor of low water concentration be supplied to the substrate W by the anhydrous vapor etching unit 7b1. The amount of water supplied to the substrate W is thereby reduced and the amount of water on the substrate W can thus be reduced to suppress or prevent the forming of residues.

Also, the controller 4 may control the first flow controller 25 and the third flow controller 35 to change a ratio of the HF vapor and the solvent vapor supplied to the substrate W in the HF vapor and solvent vapor supplying step (S2 of FIG. 3) in accordance with a removal amount of a sacrificial film. That is, as the removal amount of the sacrificial film increases, the amount of water produced due to etching increases. The controller 4 may thus increase the proportion of the solvent vapor to reliably remove the water produced due to etching from the substrate W. By thus changing the ratio of the HF vapor and the solvent vapor supplied to the substrate W, residue formation can be suppressed or prevented regardless of the removal amount of the sacrificial film.

Also, the controller 4 may supply the HF vapor to the substrate W to clean hole interiors. That is, as illustrated by a comparative example in FIG. 5A, when a hole interior is cleaned by wet etching by supplying hydrofluoric acid to the substrate W, the hydrofluoric acid does not reach a bottom portion of the hole adequately and thus particles may remain at the bottom portion of the hole. Further, an upper portion of an inner peripheral surface of the hole may become etched so that the diameter of the hole differs at the upper portion and the bottom portion. On the other hand, if the HF vapor is used as in an example shown in FIG. 5B, the HF vapor can be supplied uniformly into the hole. Thus, even if the hole is deep, degree of variation of the diameter of the hole can be suppressed or prevented and particles inside the hole can be removed reliably.

### [Second Processing Example]

A second processing example shown in FIG. 4 shall now be described. FIG. 1 and FIG. 4 shall be referenced below.

In the second processing example, the controller 4 makes the center robot CR carry the substrate W into the wet etching unit 7a. Thereafter, hydrofluoric acid is supplied to the substrate W (S5). Specifically, the controller 4 makes hydrofluoric acid be supplied from the etching nozzle 9 to the substrate W held by the spin chuck 8 to etch the substrate W. The controller 4 then makes the rinse liquid be supplied from the rinse liquid nozzle 10 to the substrate W held by the spin chuck 8 to rinse off the hydrofluoric acid on the substrate W (S6). The controller 4 then makes the spin chuck 8 rotate the substrate W at high speed to dry the substrate W (S7). After drying of the substrate W, the controller 4 makes the center robot CR carry the substrate W out from the wet etching unit 7a and carry the substrate W into the vapor etching unit 7b.

Thereafter, the controller 4 makes the vapor etching unit 7b execute the same operation as that of the first processing example. Specifically, after the substrate W has been placed on the hotplate 4 by the center robot CR, the atmosphere inside the bellows 17 is replaced with nitrogen gas (S1) as in the first processing example. Thereafter, the HF vapor and the solvent vapor are supplied to the substrate (S2) as in the first processing example. The substrate W is thereby etched. Thereafter, the solvent vapor is supplied to the substrate W (S3) as in the first processing example. The atmosphere inside the bellows 17 is then replaced with nitrogen gas again (S4) as in the first processing example. The substrate W in the dry state is then carried out from the hotplate 14 by the center robot CR.

Hydrofluoric acid and the HF vapor are thus supplied successively to the substrate W. That is, the wet etching by the hydrofluoric acid and the vapor etching by the HF vapor are performed successively. For example, when a substrate W, on which a pattern of high aspect ratio (for example, an aspect ratio of no less than 10) is formed, is dried after removing all of a sacrificial film just by wet etching, collapse of the pattern may occur. Also, in a case where all of the sacrificial film is removed just by vapor etching from such a substrate W, the amount of water produced is high because the amount of sacrificial film removed is high. Water may thus remain on the substrate W. Residues newly formed due to the presence of water may thus remain on the substrate W.

However, in the case where a pattern of high aspect ratio is formed on the substrate W, with the second processing example, the drying of the substrate W is performed after the removal of a portion (upper layer portion) of a sacrificial film as shown in FIG. 6 (wet etching to spin drying). That is, the drying of the substrate W is performed in a state where a height of an exposed portion of the pattern is low in comparison to a case where the substrate W is dried in the state where all of the sacrificial film has been removed. Collapse of the pattern is thereby suppressed or prevented. And as shown in FIG. 6, the remaining portion (lower layer portion) of the sacrificial film is removed by the supplying of the HF vapor to the substrate W (vapor etching). Collapse of the pattern is thereby suppressed or prevented. Further, the amount of the sacrificial film to be removed by vapor etching is reduced and thus the remaining of water can be suppressed or prevented. The formation of residues can thereby be suppressed or prevented.

There are cases where a pattern of high aspect ratio is formed on the substrate W and a plurality of sacrificial films of different types are formed as shown in FIG. 7. More specifically, there are cases where an upper sacrificial film is, for example, an oxide film (a film made of SiO₂) and a lower sacrificial film is, for example, a BSG film. In such a case, collapse of the pattern may occur if all of the sacrificial films are removed just by wet etching. Also, the etching rate of the oxide film by vapor etching is lower than the etching rate of the oxide film by wet etching. Removal of all of the sacrificial films by just vapor etching will thus result in a considerable increase of processing time.

However, in the second processing example illustrated here, the upper sacrificial film (oxide film) is removed by wet etching as shown in FIG. 7 and thus the time required for removing the oxide film can be shortened. Further, collapse of the pattern can be suppressed or prevented because the drying of the substrate W is performed in the state where the height of the exposed portion of the pattern is low.

The lower sacrificial film (BSG film) is then removed by supplying the HF vapor to the substrate W as shown in FIG. 7 and collapse of the pattern can thus be suppressed or prevented.

The processing time can thereby be shortened while suppressing or preventing pattern collapse and residue formation.

As described above, with the present preferred embodiment, by supplying the HF vapor and the solvent vapor to the substrate W and vaporizing the solvent on the substrate Win parallel to supplying the HF vapor and the solvent vapor, the water that forms due to etching can be removed. Residue formation can thereby be suppressed or prevented. Residue formation can thus be suppressed or prevented while suppressing or preventing pattern collapse.

Although the preferred embodiment of the present invention has been described above, the present invention is not limited to the contents of the preferred embodiment and can be variously modified within the scope of the appended claims.

For example, with each of the first processing example and the second processing example, a case where the HF vapor and the solvent vapor are supplied at the same time to the substrate has been described. However, the controller 4 may supply just one of either of the HF vapor and the solvent vapor in advance to the substrate before supplying the HF vapor and the solvent vapor to the substrate. For example, the solvent vapor may be supplied in advance to the substrate.

Also, with each of the first processing example and the second processing example, a case where the solvent vapor is supplied to the substrate after the HF vapor and the solvent vapor are supplied to the substrate has been described. However the controller 4 may replace the atmosphere of the periphery of the substrate with nitrogen gas without supplying the solvent vapor to the substrate after supplying the HF vapor and the solvent vapor to the substrate.

Also, in each of the first processing example and the second processing example, the controller 4 may control the temperature of the substrate by means of the hotplate 14 to adjust amounts of the HF vapor and the solvent vapor that liquefy on the substrate. For example, in a case where the removal amount of unwanted matter is high, the temperature of the substrate may be lowered to increase the amount of droplets of hydrogen fluoride supplied to the substrate.

Also, although with the preferred embodiment, a case where the substrate processing apparatus 1 is an apparatus that processes a circular disk-like substrate has been described, the substrate processing apparatus 1 may instead be an apparatus that processes a polygonal substrate, such as a substrate for a liquid crystal display. Also, the substrate processing apparatus 1 is not restricted to a one-by-one type substrate processing apparatus and may be a batch type substrate processing apparatus that processes a plurality of substrates in a batch.

Besides the above, various design changes may be applied within the scope of the matters described in the claims.

Although the preferred embodiments of the present invention have been described in detail, the embodiments are merely specific examples used to clarify the technical contents of the present invention, and the present invention should not be understood as being limited to these specific examples, and the spirit and scope of the present invention are limited solely by the appended claims.

The present application corresponds to Japanese Patent Application No. 2011-154632 filed in the Japan Patent Office on Jul. 13, 2011, the entire disclosure of which is incorporated herein by reference.

What is claimed is:

1. A substrate processing method for removing unwanted matter from a substrate by etching, comprising:
a removing step of supplying an HF vapor that contains hydrogen fluoride and a solvent vapor that contains a solvent capable of dissolving water and having a lower boiling point than water onto the substrate to etch and remove the unwanted matter; and
a vaporizing step of vaporizing the solvent on the substrate in parallel with the removing step.

2. The substrate processing method according to claim 1, wherein the solvent contains at least one of either of a fluorine-based solvent being capable of dissolving water and having a lower boiling point than water and an alcohol being capable of dissolving water and having a lower boiling point than water.

3. The substrate processing method according to claim 1, further comprising: a solvent vapor supplying step of supplying the solvent vapor onto the substrate in a state where the supplying of the HF vapor to the substrate is stopped after performing the removing step.

4. The substrate processing method according to claim 1, wherein the removing step includes a ratio changing step of changing a ratio of the HF vapor to the solvent vapor supplied to the substrate.

5. The substrate processing method according to claim 1, further comprising: a vapor removing step of removing the HF vapor and the solvent vapor from the substrate exposed to the HF vapor and the solvent vapor after performing the removing step.

6. The substrate processing method according to claim 1, wherein the removing step is a step of supplying, onto the substrate, the HF vapor and the solvent vapor having a water concentration that is in accordance with a type of the unwanted matter.

7. A substrate processing apparatus comprising:
a substrate holding unit that holds a substrate;
a vapor supplying unit that supplies, onto the substrate held by the substrate holding unit, an HF vapor that contains hydrogen fluoride and a solvent vapor that contains a solvent capable of dissolving water and having a lower boiling point than water;
a vaporizing unit that vaporizes the solvent on the substrate held by the substrate holding unit; and
a control unit that executes a removing step of controlling the vapor supplying unit to supply the HF vapor and the solvent vapor onto the substrate held by the substrate holding unit and thereby etch and remove unwanted matter from the substrate and a vaporizing step of controlling the vaporizing unit to vaporize the solvent on the substrate in parallel with the removing step.

8. The substrate processing apparatus according to claim 7, wherein the vapor supplying unit supplies, to the substrate held by the substrate holding unit, the solvent vapor, containing at least one of either of a fluorine-based solvent capable of dissolving water and having a lower boiling point than water and an alcohol capable of dissolving water and having a lower boiling point than water, and the HF vapor.

9. The substrate processing apparatus according to claim 7, further comprising: a solvent vapor supplying unit that supplies the solvent vapor onto the substrate held by the substrate holding unit;
wherein the control unit further executes a solvent vapor supplying step of controlling the vapor supplying unit and the solvent vapor supplying unit to supply the solvent vapor to the substrate in a state where the supplying of the HF vapor to the substrate is stopped after executing the removing step.

10. The substrate processing apparatus according to claim 7, wherein the vapor supplying unit including a ratio changing unit that changes a ratio of the HF vapor to the solvent vapor supplied to the substrate, and
the control unit executes a ratio changing step of controlling the ratio changing unit to change the ratio of the HF vapor to the solvent vapor supplied to the substrate in the removing step.

11. The substrate processing apparatus according to claim 7, further comprising: a vapor removing unit that removes a vapor;
wherein the control unit further executes a vapor removing step of controlling the vapor removing unit to remove the HF vapor and the solvent vapor from the substrate exposed to the HF vapor and the solvent vapor after executing the removing step.

12. The substrate processing apparatus according to claim 7, wherein the vapor supplying unit includes a first vapor supplying unit that supplies a first HF vapor, containing hydrogen fluoride, and the solvent vapor to the substrate held by the substrate holding unit, and a second vapor supplying unit that supplies a second HF vapor, containing hydrogen fluoride and water and being higher in water concentration than the first HF vapor, and the solvent vapor onto the substrate held by the substrate holding unit,
the control unit controls the first vapor supplying unit and the second vapor supplying unit in accordance with a type of the unwanted matter to supply either the first or the second HF vapor and the solvent vapor onto the substrate in the removing step.
